(19) United States
(12) Patent Application Publication
(10) Pub. No.: US 2018/0285905 A1
(43) Pub. Date: Oct. 4, 2018

(54) SYSTEM FOR MEASURING SUSTAINABILITY OF COMMODITY IN MARKET AND METHOD FOR MEASURING SUSTAINABILITY OF COMMODITY IN MARKET

(71) Applicant: YONSEI UNIVERSITY INDUSTRY FOUNDATION, Seoul (KR)

(72) Inventor: Eun Ju KO, Seoul (KR)

(21) Appl. No.: 15/838,858

(22) Filed: Dec. 12, 2017

(30) Foreign Application Priority Data
Mar. 31, 2017 (KR) 10-2017-0041558

(51) Int. Cl. G06Q 30/02; G06F 17/18; G06Q 10/06; G06Q 30/06

(52) U.S. Cl. CPC G06Q 30/0203; G06F 17/18; G06Q 30/0623; G06Q 10/0637; G06Q 10/067

(57) ABSTRACT

The present invention relates to a commodity's market sustainability measurement system and method for measuring a sustainability of a commodity in a market, and more particularly, to a commodity's market sustainability measurement system and method for establishing a sustainable strategy more efficiently and accurately in the fashion market and measuring a market sustainability of the commodity more precisely than measuring the market sustainability of the commodity in the three sectors of economy, environment, and society in the past by measuring market sustainability of commodity in four sectors of economy, environment, society and culture.

### CROSS-REFERENCE TO RELATED APPLICATION

This application claims priority to Korean Patent Application No. 10-2017-0041558 filed on Mar. 31, 2017 and all the benefits accruing therefrom under 35 U.S.C. § 119, the contents of which are incorporated by reference in their entirety.

### BACKGROUND

The present disclosure relates to a system for measuring the sustainability of commodity in market and a method for measuring market sustainability. More particularly, the present disclosure relates to a system for measuring the sustainability of commodity in market and a method for measuring a sustainability of a commodity in a market, which reflect a customer's evaluation.

Recent industries are focused on technology development, keeping commodity prices low, and increasing production efficiency. Commodities increase environmental impact and increase waste through the use of resources. As a result, industrial development is changing at a level that reduces environmental impacts, but production and consumption are increasing in environmental impacts as much as the benefits of technology development are reduced.

Corporate sustainability reports and Corporate Social Responsibility (CSR) reports have been presented to customers to demonstrate their sustainable activities (i.e., corporate activities), which are an important strategy for securing a competitive advantage. However, in the past, there is no system that evaluates sustainable activities of business the basis of customer's perception (or evaluation), and there is a problem that the behavior for companies' sustainability is separated from the customer. In addition, there is a problem that it is impossible to measure precisely market sustainability without knowing what customers are focusing on.

### PRIOR ART DOCUMENTS

### Patent Documents

### (PATENT DOCUMENT 1) KR 10-1488242 B

### SUMMARY

The present disclosure provides a commodity's market sustainability measurement system and a market sustainability measurement method for calculating a sustainable index (SI) in a market for commodity by receiving a customer's evaluation score.

In accordance with an exemplary embodiment, a commodity's market sustainability measurement system includes: an evaluation score input unit configured to receive a customer's evaluation score for corporate activity according to an item; a satisfaction calculation unit configured to calculate a satisfaction for each item or each customer by using the evaluation score inputted from the evaluation score input unit 110; and a sustainable index calculation unit configured to calculate a sustainable index (SI) in a market for a commodity using the satisfaction calculated in the satisfaction calculation unit.

The system may further include a multi-category unit for classifying the items into multiple categories according to a preset criterion.

The system may further include a weight setting unit for setting a weight according to importance by the item, the category or the customer for each satisfaction, wherein the satisfaction calculation unit may calculate the satisfaction by reflecting the weight.

The satisfaction calculation unit may calculate the satisfaction by Equation 1.

$${Satisfaction}^{\cdot } = \frac{E [ ζ ] - Min [ ζ ]}{Max [ ζ ] - Min [ ζ ]} \times 100 \qquad [ Equation 1 ]$$

(where, Here, ζ is a latent variable for satisfaction,

$$E [ ζ ] = {\sum }_{i = 1}^{n} {w}_{i} {x}_{i} , \\ Min [ ζ ] = {\sum }_{i = 1}^{n} {w}_{i} Min [ {x}_{i} ] , \\ Max [ ζ ] = {\sum }_{i = 1}^{n} {w}_{i} Max [ {x}_{i} ] ,$$

and x is the evaluation score (i.e., a measurement variable), w is the weight, n is the number of customers or items, Min[x] is a minimum value of the evaluation score, and Max[x] is a maximum value of the evaluation score)

The sustainable index calculation unit may calculate the SI by Equation 2.

$$SI = \frac{{\sum }_{1}^{k} Satisfaction}{k} \qquad [ Equation 2 ]$$

(where k is the number of items or customers)

The system may further include a sustainable index verification unit for verifying a calculated sustainable index based on a matrix equation for a covariance between evaluation scores for each item or each customer.

In accordance with another exemplary embodiment, a method for measuring market sustainability of a commodity includes: receiving, by an evaluation score input unit, a customer's evaluation score for corporate activity according to an item; calculating, by a satisfaction calculation unit, a satisfaction for each item or each customer by using the evaluation score inputted from the evaluation score input unit; and calculating, by a sustainable index calculation unit, a sustainable index (SI) in a market for a commodity using the satisfaction calculated in the satisfaction calculation unit.

The method may further include classifying, by a multi-category unit, the items into multiple categories according to a preset criterion.

The method may further include setting, by a weight setting unit, a weight according to importance by the item, the category or the customer for each satisfaction and the calculating of the satisfaction comprises reflecting the weight.

The calculating of the satisfaction may calculate the satisfaction by Equation 1.

$${Satisfaction}^{\cdot } = \frac{E [ ζ ] - Min [ ζ ]}{Max [ ζ ] - Min [ ζ ]} \times 100 \qquad [ Equation 1 ]$$

(where, Here, ζ is a latent variable for satisfaction,

$$E [ ζ ] = {\sum }_{i = 1}^{n} {w}_{i} {x}_{i} , \\ Min [ ζ ] = {\sum }_{i = 1}^{n} {w}_{i} Min [ {x}_{i} ] , \\ Max [ ζ ] = {\sum }_{i = 1}^{n} {w}_{i} Max [ {x}_{i} ] ,$$

and x is the evaluation score (i.e., a measurement variable), w is the weight, n is the number of customers or items, Min[x] is a minimum value of the evaluation score, and Max[x] is a maximum value of the evaluation score)

The calculating of the sustainable index may calculate the SI by Equation 2.

$$SI = \frac{{\sum }_{1}^{k} Satisfaction}{k} \qquad [ Equation 2 ]$$

(where k is the number of items or customers)

The method may further include verifying, by a sustainable index verification unit, a calculated sustainable index based on a matrix equation for a covariance between evaluation scores for each item or each customer.

### BRIEF DESCRIPTION OF THE DRAWINGS

Exemplary embodiments can be understood in more detail from the following description taken in conjunction with the accompanying drawings, in which:

FIG. 1 is a schematic diagram illustrating a commodity's market sustainability measurement system a according to an embodiment.

FIG. 2 is a flowchart illustrating a method of measuring market sustainability of a commodity according to another embodiment.

### DETAILED DESCRIPTION OF EMBODIMENTS

Hereinafter, embodiments of the present invention will be described in detail with reference to the accompanying drawings. However, the present invention may be embodied in different forms and should not be construed as limited to the embodiments set forth herein, and rather, these embodiments are provided so that this disclosure will be thorough and complete, and will fully convey the scope of the present invention to those skilled in the art. In the description, the same components are denoted by the same reference numerals, and the drawings are partially exaggerated in size to accurately describe the embodiments of the present invention, and like reference numerals refer to like elements in the drawings.

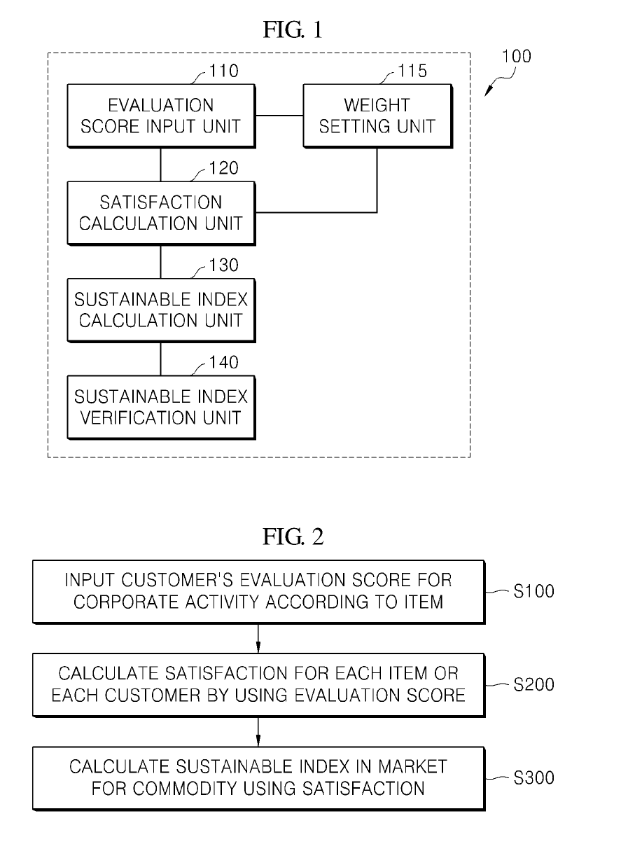

FIG. 1 is a schematic diagram illustrating a commodity's market sustainability measurement system according to an embodiment of the present invention.

Referring to FIG. 1, a commodity's market sustainability measurement system 100 according to an embodiment of the present invention includes: an evaluation score input unit (110) for receiving a customer's evaluation score for corporate activity according to an item; a satisfaction calculation unit 120 for calculating a satisfaction for each item or each customer by using the evaluation score inputted from the evaluation score input unit 110; and a sustainable index calculation unit 130 for calculating a sustainable index (SI) in a market for a commodity using the satisfaction calculated in the satisfaction calculation unit 120.

The evaluation score input unit 110 may be inputted and receive the customer's evaluation score for the corporate activity according to the item. Here, the corporate activity may be an activity that includes commodity (e.g., product or brand) and service delivery, and may be an overall corporate activity that includes corporate social responsibility (e.g., donation activity) as well as production and sales activity. And, evaluation of corporate activity may include commodity evaluation and corporate evaluation. At this time, the evaluation score input unit 110 may receive a customer's evaluation score through a survey on the customer, and the item may be a survey item.

The satisfaction calculation unit 120 may calculate a satisfaction for each item or each customer by using the evaluation score inputted and received from the evaluation score input unit 110. In such a case, customers' satisfaction may be calculated by reflecting the customer's evaluation (or recognition), and satisfaction may be selectively used by calculating the satisfaction according to the item or the customer. For example, in the case of calculating satisfaction for each item, the evaluation score of each customer may be used as a variable, and in the case of calculating satisfaction for each customer, the evaluation score of each item for each customer may be used as a variable. At this time, in the case of calculating satisfaction for each item, it is possible to know how much customers prefer to the corporate activity corresponding to each item, and in the case of calculating satisfaction for each customer, it is possible to know how much customers prefer to corporate activity (i.e., commodity or business). Through this, it is possible to identify the corporate activity or the customer base with strengths, and also the corporate activity or the customer base with weakness. Accordingly, satisfaction calculated for each item or each customer may be selectively used to establish a sustainability strategy for the company.

And, the satisfaction calculation unit 120 may calculate the satisfaction by Equation 1.

$${Satisfaction}^{\cdot } = \frac{E [ ζ ] - Min [ ζ ]}{Max [ ζ ] - Min [ ζ ]} \times 100 \qquad [ Equation 1 ]$$

Here, ζ is a latent variable for satisfaction,

$$E [ ζ ] = {\sum }_{i = 1}^{n} {w}_{i} {x}_{i} , \\ Min [ ζ ] = {\sum }_{i = 1}^{n} {w}_{i} Min [ {x}_{i} ] , \\ Max [ ζ ] = {\sum }_{i = 1}^{n} {w}_{i} Max [ {x}_{i} ] ,$$

and x is the evaluation score (i.e., a measurement variable), w is the weight, n is the number of customers or items, Min[x] is a minimum value of the evaluation score, and Max[x] is a maximum value of the evaluation score. At this point, the latent variable means a variable whose configuration concept is directly observed or may not be measured, and may be a variable related to the customer's evaluation score (for example, x or w·x). Also, i may be the order (or number) of the customer or item, xi may represent the ith customer or item, and wi may represent the weight of the ith customer or item. And, Min[xᵢ] may be a minimum value of the evaluation score of the ith customer or a minimum value of the evaluation score of the ith item, and Max[xᵢ] may be a maximum value of the evaluation score of the ith customer or a maximum value of the evaluation score of the ith item. Here, a minimum value of the evaluation score may be the lowest of the evaluation scores (i.e., the lowest score of the evaluation score to be given) or the lowest score among the scores evaluated by customers, and a maximum value of the evaluation score may be the maximum value (i.e., the highest score of the evaluation score to be given) or the highest score among the scores evaluated by customers.

The satisfaction may be calculated for each item or for each customer. If satisfaction is calculated for each item, xᵢ may be an evaluation score of each customer for the item and n may be the number of customers, and if satisfaction is calculated for each customer, xᵢ may be the evaluation score of each item of the corresponding customer and n may be the number of items. On the other hand, satisfaction may be calculated for each category, xᵢ may be an evaluation score of each customer for the category, n may be the number of customers, and the customer's evaluation score for the category may be an average value of evaluation scores of items in the category. In addition, there may be the same sub-questions for each item, xᵢ may be the evaluation score of each sub-question for the item, n may be the number of the sub-questions, and the evaluation score of the sub-question may use the evaluation score of one customer, or the average value of the evaluation scores of the entire customers. For example, the satisfaction may be customer satisfaction, and in this case, each item may have three sub-questions: general satisfaction, confirmation of expectation, and the distance from the customer's hypothetical ideal product.

Equation 1 reflects the minimum value (Min[x]) of the evaluation score and the maximum value (Max[x]) of the evaluation score rather than a general average value. In the case of using Equation 1, the position (or height) of satisfaction between the minimum and maximum values, rather than the quantitative (or generic) score, may be determined precisely.

That is, if satisfaction is obtained using the average value of the evaluation scores, in the case that the minimum value (Min[x]) of the evaluation score is greater than 0, the minimum value (Min[x]) of the evaluation score is added to the satisfaction so that it becomes higher than the actual customer's preference (or preference size) basically, but in the case of using Equation 1, the minimum value (Min[x]) of the evaluation score is not added to the satisfaction, so that the customer's preference may be accurately known. In addition, when the maximum value (Max[x]) of the evaluation score is too low, satisfaction may be lower than the actual customer's preference, but in the case of using Equation 1, the maximum value (Max[x]) of the evaluation score and the minimum value (Min[x]) of the evaluation score are reflected, so that the customer's preference may be known accurately. Moreover, if the difference between the minimum value (Min[x]) of the evaluation score and the maximum value (Max[x]) of the evaluation score is insignificant, although the ratio between evaluation scores may not be well reflected in satisfaction, in the case of using Equation 1, by multiplying 100 to make a percentage (%), the ratio between satisfaction and evaluation scores may be well reflected.

The sustainable index calculation unit 130 may calculate a sustainable index SI for a commodity in the market using the satisfaction calculated in the satisfaction calculation unit 120. Here, commodity may be a concept that includes products and the trend of products, and the market's sustainable index on commodity may be an index (or number) indicating how long the commodity may last in the market. Through this, it is possible to measure the market sustainability of the commodity by reflecting the customer's evaluation and reflect the customer's perception on the corporate activity, so that more accurate market sustainability of the commodity may be measured.

For example, the commodity may include a fashion product (e.g., clothing) and a fashion trend, and the sustainable index may indicate how long a fashion product or fashion trend may last in the market.

And, the sustainable index calculation unit 130 may calculate the SI by Equation 2.

$$SI = \frac{{\sum }_{1}^{k} Satisfaction}{k} \qquad [ Equation 2 ]$$

Here, k may be the number of items or customers, and may be the number of items in the case of satisfaction for each item, and may the number of customers in the case of satisfaction for each customer. That is, Equation 2 may be an average value of satisfaction obtained by dividing the satisfaction calculated for each item or for each customer by the number of items or the number of customers correspondingly.

In Equation 2, the sustainable index SI may be calculated by selecting the satisfaction for each item or the satisfaction for each customer, thereby obtaining the sustainable index SI corresponding to a situation (or need).

On the other hand, the sustainability index (SI) may be calculated using satisfaction for each category, and in this case, k may be the number of categories.

The commodity's market sustainability measurement system 100 according to the present invention may further include a multi-category unit (not shown) for classifying the items into multiple categories according to a preset criterion. The multi-category unit (not shown) may classify the items into multiple categories according to a preset criterion. The classification criteria of the category may be set in advance, and the multi-category unit may classify the items by each category according to the set criteria. For example, categories may be set by each sector including economic, environmental, and social and cultural sectors.

Table 1 shows a category specific classification according to an embodiment of the present invention.

| Category | Item |
|---|---|
| Economic | Price |
| | Quality |
| | Promotion |
| | Operation management |
| Environment | Recycled products/packaging |
| | Waste/energy reducing |
| | New technology/design product |
| Social | Charitable contributions |
| | Corporate reputation |
| | Employee training |
| Culture | Environment and culture protection idea |
| | in product design |
| | Culture diversity of fashion products |
| | Support for arts and cultural expression |
| | Loyalty program |

Referring to Table 1, the economic sector may include marketing strategy (price, quality, promotion) and operation management, and the environmental sector may include recycling of products or packaging, waste/energy reducing, and new technology/design products. And, the social sector may include charitable contributions, corporate reputation, employee training (behavior, communication, attitude, support), and the cultural sector may include environment and culture protection idea in product design, culture diversity of commodity (e.g., fashion products), support for arts and cultural expression (e.g., cultural well-being and local government report), and loyalty program. Here, the evaluation score may be inputted from customer for each item.

Conventionally, the market sustainability of commodity has been measured in three sectors of economy, environment, and society. In the present invention, the market sustainability of commodity may be measured in four sectors of economy, environment, society and culture. In recent years, the aesthetic design has been applied to the commodity, and as the globalization has progressed, the multicultural market has been shifted, and the importance of the cultural sector is increasing. In particular, the fashion market is more influenced by aesthetic design and cultural diversity.

The design of fashion products has value as customers prefer aesthetically pleasing products, and customers (or consumers) of fashion products feel the need to reconsider their ethical perceptions of exposure. Purchasing in relation to socially responsible lifestyle of fashion product customers and their ethical identity may symbolically represent their ethical consciousness. As customers participate in brand culture, they form their personal identity and self-image, and because art is a commodity, it is influenced by market forces and customer interests, and influenced by the introduction of celebrities. In addition, various designs in fashion products (e.g., design of environmental protection) are also an important method of cultural well-being. Maintaining the cultural diversity of fashion products is a way to maintain customer diversity, and customer diversity is a comparative advantage in the commodity's market sustainability.

Accordingly, in measuring the market sustainability of the commodity, as an item on a culture sector is provided, the accurate sustainable index SI corresponding to the latest trend may be calculated by reflecting the item on the culture sector. In addition, each item may be classified into multiple categories according to a predetermined criterion through the multi-category unit to calculate the satisfaction of the customer according to the category, thereby confirming the recognition of the customer according to the category.

The commodity's market sustainability measurement system 100 according to the present invention may further include a weight setting unit 115 for setting a weight according to importance by the item, the category or the customer for each satisfaction. The weight setting unit 115 may set a weight according to importance by the item, the category or the customer for each satisfaction. At this time, the importance may be determined according to the average value of the total customer's evaluation scores for each item, the average value of the evaluation scores of the entire customers (or items in the category) for each category, or the average value of the evaluation scores of all items (or all categories) for each customer, and a weight may be set according to the importance Also, the weight may be calculated through a factor analysis of a statistical analysis program such as Statistical Package for the Social Sciences (SPSS). Here, the SPSS may be a collection of statistical analysis programs used for statistical analysis, data mining, and the like.

The satisfaction calculation unit 120 may calculate the satisfaction by reflecting the weight. In such a case, weight may be given according to the customer's interest (or importance) on each item or category and weight may be assigned according to customer's importance, so that more accurate commodity's market sustainability may be measured according to customer's focus, and the commodity's market sustainability may be measured according to the situation.

The commodity's market sustainability measurement system 100 according to the present invention may further include a sustainable index verification unit 140 for verifying a calculated sustainable index based on a matrix equation for a covariance between evaluation scores for each item or each customer. The sustainable index verification unit 140 may verify the calculated sustainable index based on the matrix equation on the covariance between the evaluation scores for each item and each customer. Here, the covariance is an amount representing the relationship between two variables, and the sustainable index may be verified by applying the variable (x) used in Equation 1 to the matrix equation. In order to verify the sustainable index, a structural equation model may be used. Here, the structural equation is an equation representing the relationship between variables in an econometric model, and the structural equation model is a statistical technique for identifying the causal relationship between variables in a non-experimental situation. On the other hand, when the sustainability index SI is calculated by using satisfaction for each category, the sustainable index SI may be verified based on the matrix equation for a covariance between evaluation scores of each category.

As in an example of the verification result, a customer perception quality of sustainability, a customer expectation index, and a customer perception value of sustainability may positively affect sustainable commodity satisfaction (e.g., customer satisfaction), and as satisfaction on sustainable commodity increases, customer assets (or customer loyalty) of value assets, brand equity, and relationship assets may increase and thus, customer complaints may decrease. And, a reduction in customer complaints may lead to an increase in customer equity.

Here, value equity refers to the perceptional value of customer and refers to the overall evaluation on the usefulness of provided products and services in comparison to those (e.g., cost and time) provided by customer. In other words, how much customers trust the company's goods, how much quality goods have, and how much commodity is worthy are evaluated, and a value asset reflects a relatively objective customer's perception of the product or service and is a one-sided asset that is perceived by a company's product or service capability. The value asset may include the quality of the material or nonmaterial aspects of a product or service, the monetary price that customer has to give up or pay to get something, and the convenience that reduces the time and effort required to purchase or use a product or service.

Also, the brand equity refers to the degree of desirable marketing effect that a company acquires, as customers own certain brands through subjective and intangible evaluation of customers. In other words, by evaluating what image a brand is perceived as by customers and whether the image of the brand meets customer's taste, the brand equity refers to the value added to the product or service. The brand equity is evaluated as a monetary value, i.e., an intangible value in the modern market economy such as consumer perception and brand extension in addition to corporate value assets. In relation to the brand equity, brand perception, which is the ability of a consumer to identify a specific brand in a product category or to easily recall the brand name (for example, Hyundai Motor's “Sonata”), may include a brand association that is consumer's thought in relation to a brand (for example, Volkswagen→beetles), and a brand image that is more than positive or negative perception of customers through a specific brand.

And, the relationship equity refers to the degree of relationship that a company forms with a customer beyond a perceptional level of evaluation on a value or brand of a specific company. In other words, the relationship equity is an evaluation measure of how consumers perceive the value of the relationship that occurs at the customer contact point while companies offer products or services to their customers. The quality of relationship is mainly evaluated by face to face, and consumers evaluate the perception on what kind of relational benefits the company gives me and what special treatment the company provides to me. The relationship equity may include a loyalty program, which is an activity for offering several incentives to increase the loyalty of repeatedly-purchasing customers, a familiarity program, which is a marketing activity for strengthening ties with companies by grouping a special perception and treatment (means that the company perceives the customer's requirements according to the customer's group or hierarchy and applies different treatment methods accordingly) and common concerns and interests of customers, and a community program, which is a program for customers to form groups or meetings on a specific topic to build customer relationships.

Accordingly, in the present invention, the reliability of the sustainable index calculated by verifying the sustainable index through the sustainable index verification unit 140 may be confirmed, and more efficient and accurate enterprise sustainability strategies may be established. Further, it is possible to verify the sustainable index more accurately by verifying the parameter x used in Equation 1 based on the matrix equation of the covariance between item or customer specific evaluation scores, and also verify customer assets according to the satisfaction through the structural equation model.

FIG. 2 is a flowchart illustrating a method of measuring market sustainability of a commodity according to another embodiment of the present invention.

In describing the method for measuring market sustainability of a commodity according to another embodiment of the present invention in detail with reference to FIG. 2, the overlapping parts of the commodity's market sustainability measurement system according to an embodiment of the present invention will be omitted.

The method for measuring market sustainability of a commodity according to another embodiment of the present invention includes: receiving, by an evaluation score input unit, a customer's evaluation score for corporate activity according to an item (S100); calculating, by a satisfaction calculation unit, a satisfaction for each item or each customer by using the evaluation score inputted from the evaluation score input unit (S200); and calculating, by a sustainable index calculation unit, a sustainable index (SI) in a market for a commodity using the satisfaction calculated in the satisfaction calculation unit (S300).

First, the evaluation score input unit is inputted and receives the customer's evaluation score for the corporate activity according to the item (S100). Here, the corporate activity may be an activity that includes commodity (e.g., product or brand) and service delivery, and may be an overall corporate activity that includes corporate social responsibility (e.g., donation activity) as well as production and sales activity. And, evaluation of corporate activity may include commodity evaluation and corporate evaluation. At this time, the evaluation score input unit may receive a customer's evaluation score through a survey on the customer, and the item may be a survey question.

Then, the satisfaction calculation unit calculates satisfaction for each item or each customer by using the evaluation score inputted and received from the evaluation score input unit (S200). In such a case, customers' satisfaction may be calculated by reflecting the customer's evaluation (or recognition), and satisfaction may be selectively used by calculating the satisfaction according to the item or the customer. For example, in the case of calculating satisfaction for each item, the evaluation score of each customer may be used as a variable, and in the case of calculating satisfaction for each customer, the evaluation score of each item for each customer may be used as a variable. At this time, in the case of calculating satisfaction for each item, it is possible to know how much customers prefer to the corporate activity corresponding to each item, and in the case of calculating satisfaction for each customer, it is possible to know how much customers prefer to corporate activity. Through this, it is possible to identify the corporate activity or the customer base with strengths, and also the corporate activity or the customer base with weakness. Accordingly, satisfaction calculated for each item or each customer may be selectively used to establish a sustainability strategy for the company.

Then, the sustainable index calculation unit 130 calculates a sustainable index SI for a commodity in the market using the satisfaction calculated in the satisfaction calculation unit (S300). Here, commodity may be a concept that includes products and the trend of products, and the market's sustainable index on commodity may be an index indicating how long the commodity may last in the market. Through this, it is possible to measure the market sustainability of the commodity by reflecting the customer's evaluation and reflect the customer's perception on the corporate activity, so that more accurate market sustainability of the commodity may be measured.

The commodity's market sustainability measurement method according to the present invention may further include classifying, by a multi-category unit, the items into multiple categories according to a preset criterion.

The multi-category unit may classify the items into multiple categories according to a preset criterion (S110). Each item may be classified into multiple categories according to a predetermined criterion through the multi-category unit to calculate the satisfaction of the customer according to the category, thereby confirming the recognition of the customer according to the category. In addition, in measuring the market sustainability of the commodity, as an item on a culture sector is provided, the accurate sustainable index SI corresponding to the latest trend may be calculated by reflecting the item on the culture sector.

The commodity's market sustainability measurement method according to the present invention may further include setting, by a weight setting unit, a weight according to importance by the item, the category or the customer for each satisfaction (S150) and the calculating of the satisfaction (S200) may include reflecting the weight (S210).

The weight setting unit may set a weight according to importance by the item, the category or the customer for each satisfaction (S150). At this time, the importance may be determined according to the average value of the total customer's evaluation scores for each item, the average value of the evaluation scores of the entire customers (or items in the category) for each category, or the average value of the evaluation scores of all items (or all categories) for each customer, and a weight may be set according to the importance In addition, the weight may be calculated through factor analysis of SPSS. Here, the SPSS may be a collection of statistical analysis programs used for statistical analysis, data mining, and the like.

In the calculating of the satisfaction (S200), the weight may be reflected on the evaluation score (S210). In such a case, weight may be given according to the customer's interest (or importance) on each item or category and weight may be assigned according to customer's importance, so that more accurate commodity's market sustainability may be measured according to customer's focus, and the commodity's market sustainability may be measured according to the situation.

And, in the calculating of the satisfaction (S200), the satisfaction may be calculated by Equation 1.

Equation 1 reflects the minimum value (Min[x]) of the evaluation score and the maximum value (Max[x]) of the evaluation score rather than a general average value. In the case of using Equation 1, the position of satisfaction between the minimum and maximum values, rather than the quantitative score, may be determined precisely.

In the calculating of the sustainable index (S300), the sustainable index SI may be calculated by Equation 2.

In Equation 2, the sustainable index SI may be calculated by selecting the satisfaction for each item, the satisfaction for each category, or the satisfaction for each customer, thereby obtaining the sustainable index SI corresponding to a situation.

The commodity's market sustainability measurement method according to the present invention may further include verifying, by a sustainable index verification unit, a calculated sustainable index based on a matrix equation for a covariance between evaluation scores for each item or each customer (S400).

The sustainable index verification unit may verify the calculated sustainable index based on the matrix equation on the covariance between the evaluation scores for each item and each customer (S400). In the present invention, the reliability of the sustainable index calculated by verifying the sustainable index through the sustainable index verification unit may be confirmed, and more efficient and accurate enterprise sustainability strategies may be established. Further, it is possible to verify the sustainable index more accurately by verifying the parameter x used in Equation 1 based on the matrix equation of the covariance between item, category, or customer specific evaluation scores, and also verify customer assets according to the satisfaction through the structural equation model.

As described above, according to the present invention, the customer's evaluation score of the corporate activity is received according to the item, and the satisfaction is calculated for each item or for each customer, and by using the calculated satisfaction, it is possible to calculate the market sustainable index for commodity. Accordingly, it is possible to measure the market sustainability of the commodity by reflecting the customer's evaluation and reflect the customer's perception on the corporate activity, so that more accurate market sustainability of the commodity may be measured. In addition, weight may be assigned according to customers' interest for each item, so that it is possible to measure more accurate market sustainability of commodity according to customer's point of view. Moreover, the reliability of a calculated sustainable index may be confirmed by verifying the sustainable index based on the matrix equation on the covariance between item and customer evaluation scores, and it is possible to establish a more efficient and accurate corporate sustainability strategy. Moreover, each item may be classified into multiple categories according to a predetermined criterion to calculate the satisfaction of the customer according to the category, thereby confirming the recognition of the customer according to the category.

The commodity's market sustainability measurement system according to an embodiment of the present invention receives the customer's evaluation score of the corporate activity according to the item to calculate the satisfaction for each item or for each customer, and calculates the market sustainable index for commodity by using the calculated satisfaction. Accordingly, it is possible to measure the market sustainability of the commodity by reflecting the customer's evaluation and reflect the customer's perception on the corporate activity, so that more accurate market sustainability of the commodity may be measured.

In addition, weight may be assigned according to customers' interest for each item, so that it is possible to measure more accurate market sustainability of commodity according to customer's point of view.

Moreover, the reliability of a calculated sustainable index may be confirmed by verifying the sustainable index based on the matrix equation on the covariance between item and customer evaluation scores, and it is possible to establish a more efficient and accurate corporate sustainability strategy.

Moreover, each item may be classified into multiple categories according to a predetermined criterion to calculate the satisfaction of the customer according to the category, thereby confirming the recognition of the customer according to the category.

Although the system for measuring the sustainability of commodity in market and the method for measuring market sustainability have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. A commodity's market sustainability measurement system comprising:
an evaluation score input unit configured to receive a customer's evaluation score for corporate activity according to an item;
a satisfaction calculation unit configured to calculate a satisfaction for each item or each customer by using the evaluation score inputted from the evaluation score input unit; and
a sustainable index calculation unit configured to calculate a sustainable index (SI) in a market for a commodity using the satisfaction calculated in the satisfaction calculation unit.

2. The system of claim 1, further comprising a multi-category unit for classifying the items into multiple categories according to a preset criterion.

3. The system of claim 2, further comprising a weight setting unit for setting a weight according to importance by the item, the category or the customer for each satisfaction,
wherein the satisfaction calculation unit calculates the satisfaction by reflecting the weight.

4. The system of claim 1, wherein the satisfaction calculation unit calculates the satisfaction by Equation 1.
[Equation 1]
$${Satisfaction}^{\cdot } = \frac{E [ ζ ] - Min [ ζ ]}{Max [ ζ ] - Min [ ζ ]} \times 100 \qquad$$
(where, Here, ζ is a latent variable for satisfaction,
$$E [ ζ ] = {\sum }_{i = 1}^{n} {w}_{i} {x}_{i} , \\ Min [ ζ ] = {\sum }_{i = 1}^{n} {w}_{i} Min [ {x}_{i} ] , \\ Max [ ζ ] = {\sum }_{i = 1}^{n} {w}_{i} Max [ {x}_{i} ] ,$$
and x is the evaluation score (i.e., a measurement variable), w is the weight, n is the number of customers or items, Min[x] is a minimum value of the evaluation score, and Max[x] is a maximum value of the evaluation score)

5. The system of claim 1, wherein the sustainable index calculation unit calculates the SI by Equation 2.
$$SI = \frac{{\sum }_{1}^{k} Satisfaction}{k} \qquad [ Equation 2 ]$$
(where k is the number of items or customers)

6. The system of claim 1, further comprising a sustainable index verification unit for verifying a calculated sustainable index based on a matrix equation for a covariance between evaluation scores for each item or each customer.

7. A method for measuring market sustainability of a commodity, the method comprising:
receiving, by an evaluation score input unit, a customer's evaluation score for corporate activity according to an item;
calculating, by a satisfaction calculation unit, a satisfaction for each item or each customer by using the evaluation score inputted from the evaluation score input unit; and
calculating, by a sustainable index calculation unit, a sustainable index (SI) in a market for the commodity using the satisfaction calculated in the satisfaction calculation unit.

8. The method of claim 7, further comprising classifying, by a multi-category unit, the items into multiple categories according to a preset criterion.

9. The method of claim 8, further comprising setting, by a weight setting unit, a weight according to importance by the item, the category or the customer for each satisfaction and
the calculating of the satisfaction comprises reflecting the weight.

10. The method of claim 7, wherein the calculating of the satisfaction calculates the satisfaction by Equation 1.
$${Satisfaction}^{\cdot } = \frac{E [ ζ ] - Min [ ζ ]}{Max [ ζ ] - Min [ ζ ]} \times 100 \qquad [ Equation 1 ]$$
(where, Here, ζ is a latent variable for satisfaction,
$$E [ ζ ] = {\sum }_{i = 1}^{n} {w}_{i} {x}_{i} , \\ Min [ ζ ] = {\sum }_{i = 1}^{n} {w}_{i} Min [ {x}_{i} ] , \\ Max [ ζ ] = {\sum }_{i = 1}^{n} {w}_{i} Max [ {x}_{i} ] ,$$
and x is the evaluation score (i.e., a measurement variable), w is the weight, n is the number of customers or items, Min[x] is a minimum value of the evaluation score, and Max[x] is a maximum value of the evaluation score)

11. The method of claim 7, wherein the calculating of the sustainable index calculates the SI by Equation 2.
$$SI = \frac{{\sum }_{1}^{k} Satisfaction}{k} \qquad [ Equation 2 ]$$
(where k is the number of items or customers)

12. The method of claim 7, further comprising verifying, by a sustainable index verification unit, a calculated sustainable index based on a matrix equation for a covariance between evaluation scores for each item or each customer.
